(19) United States
(12) Patent Application Publication
(10) Pub. No.: US 2024/0084640 A1
(43) Pub. Date: Mar. 14, 2024

(54) CASH SPOILING SYSTEM

(71) Applicant: ASSI Global Limited, London (GB)

(72) Inventors: Steven Hill, Bristol (GB); Henry Hill, Bristol (GB)

(21) Appl. No.: 17/909,558

(22) PCT Filed: Feb. 22, 2021
(86) PCT No.: PCT/GB2021/050431

§ 371 Date: Dec. 6, 2022

(30) Foreign Application Priority Data
Mar. 6, 2020 (GB) 2003301.5

(51) Int. Cl. E05G 1/14; G07D 11/125

(52) U.S. Cl. CPC E05G 1/14; G07D 11/125

(57) ABSTRACT

An apparatus (10) for spoiling banknotes (103) arranged in a block formation within a cassette (100). The apparatus (10) comprises a cassette (100) for carrying a block of banknotes (103), a main housing (20) in which is located at least one cartridge (31) containing a spoiling fluid, and first and second spray bars (61, 62) extending from the housing (20). The spray bars (61, 62) are in fluid communication with the at least one cartridge (31), and the main housing (20) further comprises a valve (40) configured to release the spoiling fluid from the at least one cartridge (31) and into the spray bars (61, 62). In use, the first spray bar (61) extends across the length and proximate a first end of the block of banknotes (103) within the cassette (100) and the second spray bar (62) extends across the length and proximate a second end of the block of banknotes (103) within the cassette (100). The spray bars (61, 62) disperse the spoiling fluid over first and second ends and along the entire length of the block of banknotes (103) within the cassette (100) and a central portion along the entire length of the block of banknotes (103) remains free from spoiling fluid.

The present invention relates to a cash spoiling system inter alia for use in automatic teller machines (ATMs) which spoils banknotes in the event of an attempted theft. More specifically, the present invention relates to improvements in a cash spoiling system which spoils notes, rendering them unusable, but which also allows for individual notes to be subsequently authenticated.

Brute force attacks on ATM machines are a common form of robbery by thieves intending to steal the cash contained within an ATM. Often, and in the case of stand-alone ATM machines of the type found in convenience stores for example, the ATM machines are generally not secured in place and may simply be picked up by thieves and taken away. Following this, and without time constraints, the thieves use various tools to cut open the machine to obtain the cash.

In the case of ATM machines which are typically located within the structural walls of banks or supermarkets, for example, it is becoming increasingly common for thieves to use heavy duty construction vehicles to rip the ATM from the wall of the building. In some cases, it has been known to use explosives to achieve the same result. Aside from the financial implications resulting from the loss of the cash contained within the ATM, the costs for repairing the structural damage caused to the building, which by this time is unsafe for public access, are highly significant.

Typically, refillable cassettes are used to store banknotes in ATMs. The cassettes, which contain various denominations of banknotes are installed in a carriage located within the ATM in a manner which allows individual banknotes to be accessed by a user of the ATM. Standard practice for replenishing the ATM with banknotes generally involves removing the empty cassettes and replacing them with a new set of pre-filled cassettes.

Various methods of deterring theft already exist and include cash spoiling systems which activate in response to an appropriate signal indicative of an attempted theft. Known spoiling systems include the release of an indelible dye or ink onto the banknotes within the cassette when a signal is received from a sensor indicating that the ATM is being tampered with. Such inks or dyes stain the banknotes with the intention of rendering them unusable and hence worthless.

Given the increased automated nature of today's service providers however, many types of machines exist which accept notes for payment. The acceptance of notes is based purely on the structural integrity of the notes received by the machine and only notes whose physical integrity has been compromised will be rejected. Consequently, stained notes are generally accepted in such machines and are only discovered after the machine is emptied or when the spoiled notes are presented to the bank.

In the case of the gaming industry, for example, bets can be made through depositing notes in automated machines. It is however, possible to cancel a transaction prior to a bet taking place, at which point a token or ticket is printed detailing the amount owed. The ticket is then exchanged over the counter for cash. This essentially provides a thief with an undiscoverable method of exchanging the stained notes for legal tender.

Another known method of spoiling banknotes involves the use of an adhesive as the spoiling agent. The adhesive is deposited over the banknotes which acts to bond them together, and in some cases then curing, to form what is essentially a solid block of banknotes. In such systems however, the adhesive is simply sprayed into the cassette over the notes in a non-uniform chaotic manner in an attempt to ensure that all of the notes are bonded together to render them useless.

The problem associated with such adhesive systems is that individual notes cannot be subsequently partly separated to be properly authenticated.

Since the adhesive is deposited over the banknotes in an unpredictable and disorderly manner, it is not possible to guarantee that all of the notes are rendered unusable as it is possible that some of the notes may still be individually peeled away from one another. Alternatively and additionally, if notes are bonded together to form a solid block, they are no longer individually identifiable to the responsible authority (e.g. The Bank of England in the United Kingdom).

The ability to be able to identify the banknotes as authentic is essential if the responsible authority is to replace each spoiled note with new legal tender. Not being able to do so means that those notes are not replaced and any resulting financial loss must be incurred by the aggrieved party.

GB2476061B describes a cassette for storing banknotes which includes a spoiling system. This cassette has a means for detecting interference, which if detected, activates the spoiling system dispensing a degrading agent onto the interior of the inner cassette.

GB2340879B describes a cassette for storing banknotes which includes a cash spoiling system. In this system, a spoiling/bonding solution is sprayed over the banknotes following activation of the system. The solution is contained within a receptacle and expels the adhesive in response to a warning signal received from a beacon. The solution is sprayed from a delivery tube attached to a holding plate of the cassette. There is no disclosure of the mechanism by which the solution is dispersed.

Tests have shown that adhesive sprayed from the side of the holding plate is not effective over the entire length of the block of notes because the holding plate, by its very purpose, rests against the top of the block of notes and, as such, any gap between the plate and the notes is minimal. Consequently, the solution will be expelled primarily at points where gaps are present or are the most prevalent. The solution therefore is only effectively dispersed over those areas where the notes are smaller (five pound notes rather than twenty pound notes for example) or where no notes are present if the cassette is not completely filled. The remainder of the notes remain unspoilt.

Moreover, the system disclosed in GB2340879B (all be it in very limited detail) would require the interior of the cassette to be disassembled and adapted to connect and fit the delivery tube to the holding plate. This makes retrofitting of the apparatus difficult.

GB2524177 describes a cassette for storing banknotes which includes a cash spoiling system. In this system, a spoiling/bonding solution is sprayed from a single tube, along one side of the banknotes following activation of the system. Bonding only one side of the banknotes means that it may be possible for thieves to remove more than 51% A of the spoiled note and to consequently still use it as legal tender.

Furthermore, the system described in GB2524177 also employs a gas cylinder to expel glue onto the banknotes. However, tests of this system have shown that such a method of expulsion of the glue is unreliable and uncontrolled. This leads to unpredictable results.

In the prior art described, the unpredictable depositing of the degrading agent renders it not possible for the spoiling system to work in such a way as to ensure that each banknote is completely unusable and still identifiable as authentic.

This and other disadvantages are overcome, or at least alleviated, with the spoiling system in accordance with the present invention.

The present invention sprays glue in such a way that the glue is applied to both opposing edges of a stack of banknotes, but is not applied to a central portion lengthways along the stack. The adhesive is also expelled in a more consistent and reliable manner than known systems. This enables the responsible authority (e.g. The Bank of England in the United Kingdom) to reliably authenticate the notes and to reimburse the ATM deployer for the cash spoiled. The present invention is easier and cheaper to produce than, for example prior art such as GB2524177, as well as far more robust. The present invention is also able to fit and be used on different manufacturers' cassettes.

According to a first aspect of the present invention there is provided apparatus for spoiling banknotes as defined in the appended independent apparatus claim. Further preferable features of the apparatus of the present invention are defined in the appended dependent apparatus claims.

According to a further aspect of the present invention there is provided a method for spoiling banknotes as defined in the appended independent method claim. Further preferable features of the method of the present invention are defined in the appended dependent method claims.

The invention will now be described by way of example only and with reference to the accompanying drawings in which:—

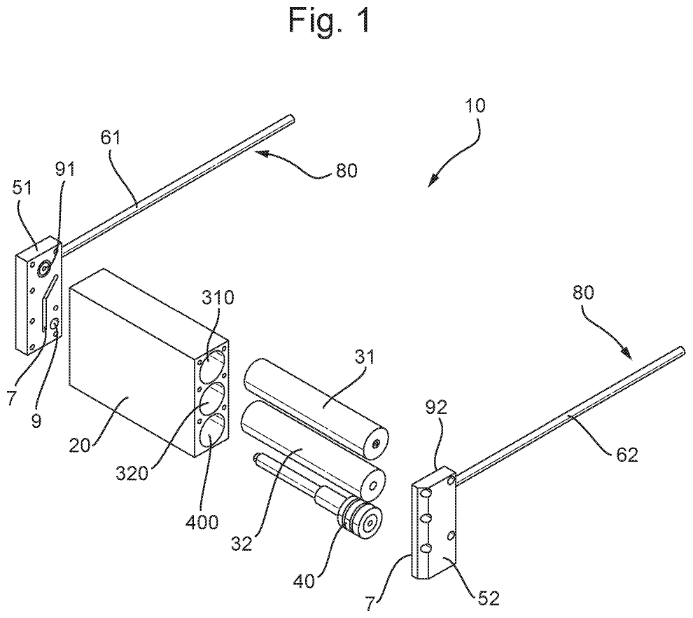

FIG. 1 is an exploded view of the cash spoiling apparatus according to the present invention;

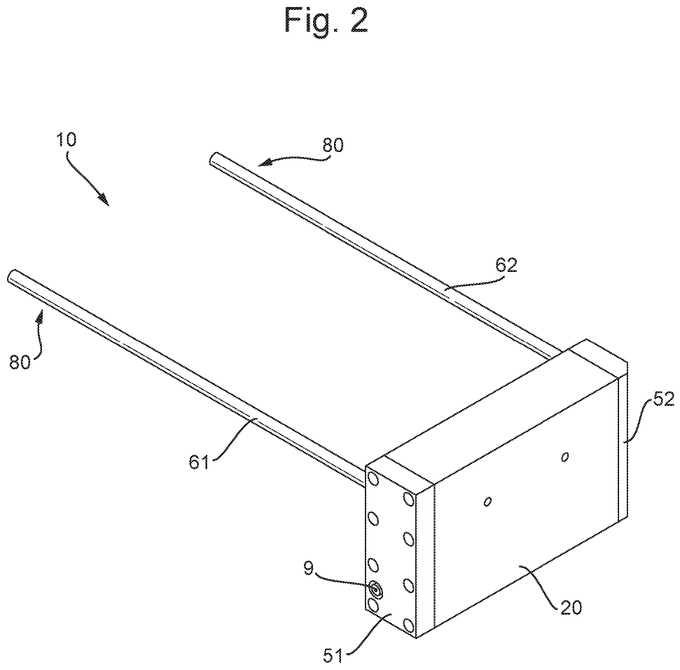

FIG. 2 shows a perspective view of the cash spoiling apparatus of FIG. 1;

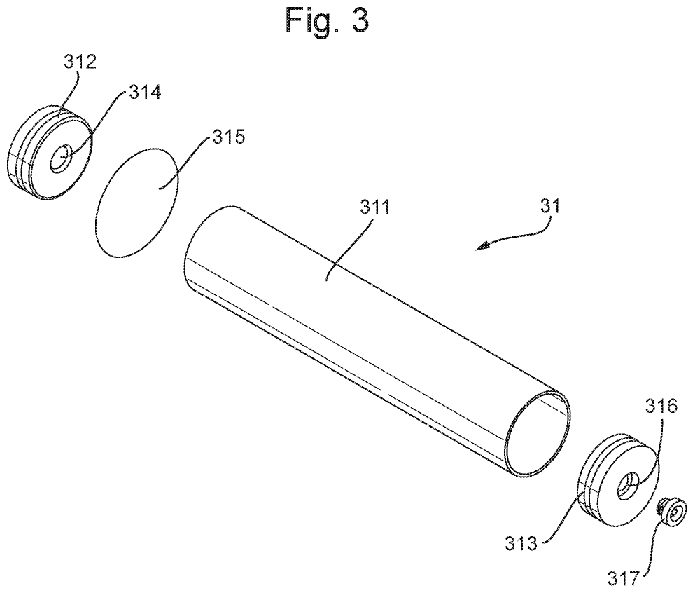

FIG. 3 is an exploded view of one of the cartridges shown in FIG. 1;

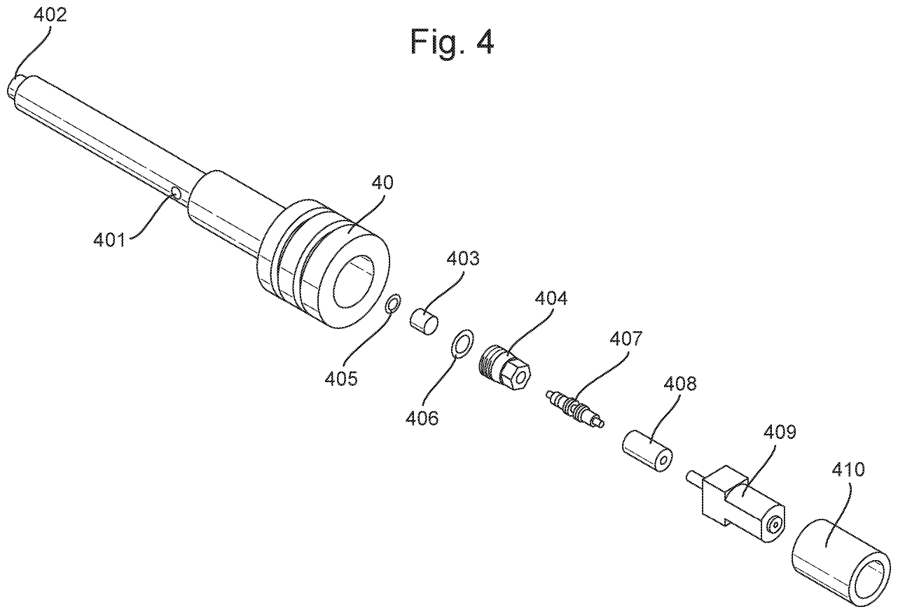

FIG. 4 is an exploded view of the valve shown in FIG. 1; and

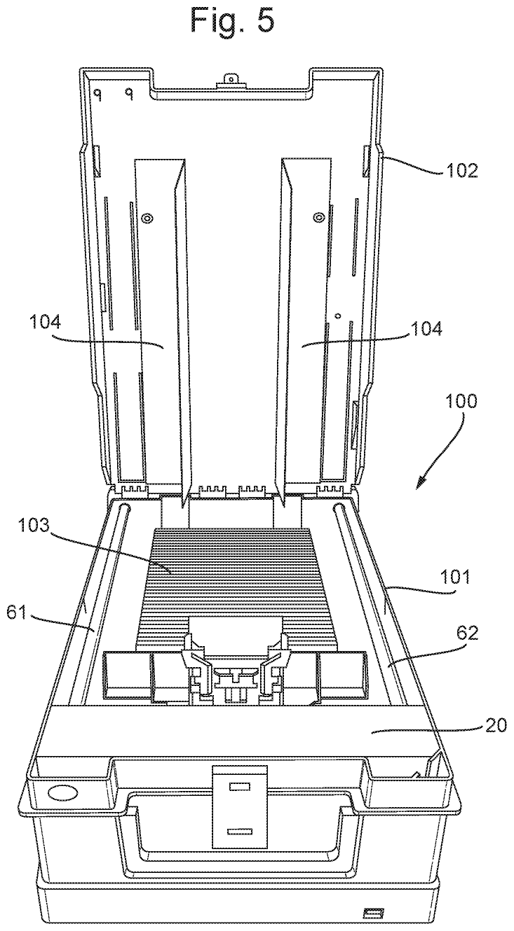

FIG. 5 shows the cash spoiling apparatus of the present invention arranged in a cassette housing a block of banknotes.

Referring firstly to FIG. 1, the apparatus (10) is shown and comprises a main housing (20) within which are two cartridges (31, 32) and a valve (40). First and second end plates (51, 52) secure the cartridges (31, 32) and valve (40) into the housing (20) via fixings (not shown) and first and second spray bars (61, 62) extend, respectively, from said end plates (51, 52). The first and second cartridges (31, 32) and the valve (40) are secured respectively in three tubular hollow valve chambers (310, 320, 400) which run the length of the housing (20) and are positioned one above another. The diameter of the valve chambers (310, 320, 400) is fractionally greater than the largest diameter of the cartridges (31, 32) and valve (40) respectively, such that, on assembly, the cartridges (31, 32) and valve (40) slide into the valve chambers (310, 320, 400) and form a snug fit.

The main housing (20) is made from metal or polymer and is substantially cuboid in shape, with rectangular opposing front and rear faces, rectangular opposing left and right faces, and rectangular opposing upper and lower faces.

The first and second spray bars (61, 62) extend from the first and second end plates (51, 52) which cover the left and right faces of the housing (20).

As can be seen best from FIG. 2, the spray bars (61, 62) each have a distal, or free end, ultimate from the main housing (20) and a proximal end, connected to the end plates (51, 52). The spray bars (61, 62) extend in parallel from the housing (20), proximate the upper face, and perpendicular to the rear face and are attributed with a series of apertures (80), not shown in the figures, along their length.

The spray bars (61, 62) are tubular with an interior conduit which runs along their length, fluidly connecting the apertures (80) and making each spray bar tube hollow. The first and second spray bars (61, 62) fit into a hole (not shown) in the first and second end plates (51, 52) respectively at the proximal end and are each terminated at the distal end with an insert (also not shown in the figures). As shown best in FIG. 1, a communicating hole (91) in the first end plate (51) provides a fluid pathway from the first cartridge (31) to the first spray bar (61). A similar communicating hole (92) in the second end plate (52) provides a fluid pathway from the second cartridge (32) to the second spray bar (62).

The cartridges (31, 32), one of which is shown in FIG. 3, contain spoiling fluid (for example a liquid adhesive such as Cyanoacrylate blend) and comprise a hollow tube (311) with a plug (312) at one end and a piston (313) at the other end. The plug (312) is circular and comprises an aperture (314) at its centre such that spoiling fluid from the cartridge can pass through the middle of the plug (312). Fluid is prevented from passing through the aperture (314) at the centre of the plug (312) by a membrane (315), for example low density polyethylene (LDPE), formed over the plug (312) and aperture (314), and positioned between the plug (312) and the hollow tube (311). The plug (312) is sized so as to form a friction tight fit when pushed into the end of the hollow tube (311). When fitted into the hollow tube (311) the plug (312) holds the membrane (315) in place.

The piston (313) is also circular in shape and sized such that it can be friction tight fitted into the end of the hollow tube (311) opposite the plug (312). The piston (313) comprises an aperture (316) at its centre which is sealed with a removable bung (317). The aperture (316) in the piston (313) enables the cartridge to be filled with spoiling fluid. Both the plug (312), the piston (313), and the bung (317) have hermetic seals around their circumference.

The valve (40) is shown in FIG. 4 and consists of a tubular bar made from metal or polymer, the tubular bar having a hollow core which runs axially and the full length of the valve (40). The valve (40) comprises four external diameters; the largest external diameter at the proximal end, stepping down to the second largest external diameter proximate the largest diameter of the valve (40), stepping down again to the third largest external diameter proximate the distal end of the valve (40), and stepping down one more time to the smallest external diameter at the distal end of the valve (40).

The largest diameter portion of the valve (40) is of a diameter substantially that of the first and second cartridges (31, 32) and may include rubber O-rings around its circumference such that it may form a friction tight fit when located in the tubular hollow portion (400) in the housing (20).

An aperture in the third largest diameter portion of the valve (40) provides an inlet port (401) to the hollow core of the valve (40). The valve (40) is open at the distal end and this axially located opening provides an outlet port (402).

The valve (40) houses a solid cylindrical shuttle (403) which is allowed a short freedom of travel axially within the hollow core of valve (40) and across the inlet port (401). The freedom of travel of the shuttle (403) is restricted by a step towards the distal end of the valve (40) and a threaded adapter (404) towards the proximal end of the valve (40). Both the step and the threaded adapter (404) benefit from a pressure tight seal with the core of the valve (40) via a first O-ring (405) proximate the distal end of the valve (40) and a second O-ring (406) proximate the proximal end of the valve (40).

A Presta (RTM) valve (407) is fixed axially at its distal end to the proximal end of the threaded adapter (404) and a coupler (408) is fixed axially at its distal end to the proximal end of the Presta (RTM) valve (407). The coupler (408) is also fixed axially at its proximal end to the distal end of a motor-gearbox (409) and the motor-gearbox locates within the core of the valve (40) via a surrounding tubular shroud (410).

Referring back to FIG. 1, channels (7) in the interior facing face of each of the end plates (51, 52) provide a fluid pathway from the outlet port (402) of the valve (40) to each of the pistons (313) in the first and second cartridges (31, 32). The cartridges (31, 32) are located in the valve chambers (310, 320, 400) of the housing (40) in opposing orientation to each other.

The operation of the cash spoiling apparatus (10) is as follows.

The valve chamber (400) around the valve (40) is pressurised (typically at 21 bar) with gas, for example CO₂ or air, via a valve (9) in the first end plate (51). The valve (9) in the first end plate (51) may be a Schrader valve.

On assembly, the shuttle (403) embedded in the core of the valve (40) is installed against a reduction step (not shown) proximate the outlet port (402), thereby sealing off the outlet port (402) and preventing any gas/air loss.

The quiescent state of the apparatus remains until the motor-gearbox (409) is activated causing it to turn the coupler (408) which unscrews/depresses the Presta (RTM) valve (407). This enables the gas/air contained in the chamber (400) to flow through the core of the valve (40) and escape around the motor-gearbox (409). The resulting pressure drop in the core of the valve (40) moves the shuttle (403) from its sealed position against the reduction step, across the inlet port (401), to the threaded adapter (404). The outlet port (402) is now completely open and the Presta (RTM) valve (407) is closed. The full pressure from the valve chamber (400) transfers via the channels (7) in the end plates (51, 52) to each of the pistons (313) in the first and second cartridges (31, 32).

The pistons (313) in each of the cartridges (31, 32) are forced towards the membrane (315) of said cartridge (31, 32) which causes the spoiling fluid contained within the cartridge to rupture said membrane (315). The spoiling fluid now travels out of the cartridge (31, 32) and along the interior conduit of the respective spray tubes (61, 62).

The apertures (80) distributed along the length of the spray tubes (61, 62) disperse the spoiling fluid.

In use, the cash spoiling apparatus (10) is fixed inside a cassette (100) which is used for holding banknotes (103) contained in an ATM. This is shown in FIG. 5.

The cassette (100) is one which is commonly used in the market today and comprises a box-like structure with a base (101) and a hinged upper lid (102). In use, banknotes (103) are placed in the cassette (100) and are arranged in a uniform rectangular block across the width of the cassette (100) and extend length-ways, with the face of each individual note neatly arranged against its neighbour, as illustrated.

Once the banknotes (103) are in place, the hinged lid (102) is then closed and secured to the base (101) using a standard securing mechanism.

The cash spoiling apparatus (10) is fitted into the cassette (100) such that the housing (20) spans the width of the cassette (100) and abuts the front interior face of the cassette (100) (ultimate from the lid (102) hinges). The spray bars (61, 62) run lengthways down the right and left interior sides of the cassette (100).

Two parallel adjacent note guides (104) are located on the interior face of the lid (102), which, when the lid (102) is closed, rest on the banknotes (103) and assist in holding the notes (103) in place. The note guides (104) have a bottom face and a side face extending perpendicularly therefrom to form an L-shaped cross sectional profile. The two note guides (104) oppose each other such that the perpendicularly extending faces are proximate one another, with a spacing therebetween.

As can be seen in FIG. 5, the note guides (104) are spaced apart on the lid (102). The spacing of the note guides (104) is determined by the size of banknote (103) placed in the cassette (100).

When a signal is received from a sensor indicating that the ATM is being tampered with the cash spoiling apparatus (10) is activated and, in the manner described above, the spoiling fluid is dispersed. Tampering may include detecting if the ATM or contents is tilted, if gas is sensed, if the ATM or parts within it are heated, if someone tries to drill through any part of the ATM, etc.

The spoiling fluid is dispersed directly along the edge of the banknotes proximate the first and second spray bars (61, 62) and the spoiling fluid also ricochets off the note guides (104) and onto the banknotes (103) secured below. The width of the note guides (104) determines how far the spoiling fluid ricochets off them and, in turn, how far along the banknotes (103) the spoiling fluid is spread. The spacing apart of the note guides (104) determines the width of the portion of the banknotes (103) which remains substantially free from spoiling fluid after said fluid has been dispersed.

The spoiling fluid is directed in a substantially linear, predictable and orderly manner along an area of the banknotes (103) proximal to the spray bars (61, 62). Similarly, the spoiling fluid is directed in a predictable and orderly manner along the upper most side of the block of banknotes (103) (proximate the lid (102) of the cassette (100).

Accordingly, when the spoiling fluid has been dispersed, the banknotes (103) are bonded at both ends, leaving a free, un-bonded portion in the middle (the size of which, as mentioned above, is determined by the width of the note guides (104). If a banknote (103) is able to be peeled away at both bonded ends, obvious physical damage will be caused (tearing or surface disfigurement) rendering the note unusable to such an extent that it will be rejected by any machine. Additionally, as the middle portion of the banknotes (103) is not bonded, it is possible for each individual banknote (103) to be authenticated. This enables the responsible authority (e.g. The Bank of England in the United Kingdom) to reliably authenticate the notes and to reimburse the ATM deployer for the cash spoiled.

The present invention has the distinct advantage over a system that bonds only one side of the banknotes in that bonding only one side of the banknotes means that it may be possible for thieves to remove more than 51% of the spoiled note and to consequently still use it as legal tender.

It will be appreciated that the spoiling agent used in the present invention can vary, for example, it may be an adhesive, dye, an acidic or alkali corrosive solution or any other such fluid material may be used to cause obvious damage both ends of banknotes whilst enabling each individual bank note to be authenticated via a non-spoiled middle portion. It is also possible to add DNA markers to the glue to aid in the identification of recovered stolen bank notes.

It will also be appreciated that the foregoing is merely descriptive of example embodiments of this invention and that modifications can readily be made to these embodiments without departing from the true scope of the invention as set out in the appended claims.

1. An apparatus (10) for spoiling banknotes (103) arranged in a block formation within a cassette (100), the apparatus (10) comprising:
a cassette (100) for carrying a block of banknotes (103);
a main housing (20) in which is located at least one cartridge (31) containing a spoiling fluid,
and first and second spray bars (61, 62) extending from the housing (20);
wherein the spray bars (61, 62) are in fluid communication with the at least one cartridge (31), and the main housing (20) further comprises a valve (40) configured to release the spoiling fluid from the at least one cartridge (31) and into the spray bars (61, 62),
and wherein, in use, the first spray bar (61) extends across the length and proximate a first end of the block of banknotes (103) within the cassette (100) and the second spray bar (62) extends across the length and proximate a second end of the block of banknotes (103) within the cassette (100) such that the spray bars (61, 62), in use, disperse the spoiling fluid over first and second ends and along the entire length of the block of banknotes (103) within the cassette (100) and a central portion along the entire length of the block of banknotes (103) remains free from spoiling fluid.

2. An apparatus according to claim 1, wherein the spoiling fluid is an adhesive.

3. An apparatus according to claim 1 or claim 2, wherein the cassette (100) comprises a box-like structure with a lid (102) and wherein two adjacent note guides (104) are located on the interior face of the lid (102), which, when the lid (102) is closed, rest on the banknotes (103) and assist in holding the banknotes (103) in place.

4. An apparatus according to claim 3, wherein the note guides (104) are spaced apart on the underside of the lid (102) and the spacing apart of the note guides (104) determines the width of the portion of the banknotes (103) which, in use, remains substantially free from spoiling fluid after said fluid has been dispersed.

5. An apparatus according to claim 4, wherein the spray bars (61, 62) are proximate the underside of the lid (102).

6. An apparatus according to any of the preceding claims, wherein the valve (40) configured to release the spoiling fluid from the at least one cartridge (31) is activated by a signal indicative of an attempted theft.

7. An apparatus according to any of the preceding claims, wherein channels (7) in the interior facing face of each of the end plates (51, 52) provide a fluid pathway from the valve (40) to the first and second cartridges (31, 32).

8. An apparatus according to any of the preceding claims, wherein the cartridges (31, 32) are located in opposing orientation to each other.

9. An apparatus according to any of the preceding claims, wherein the valve (40) is secured within a valve chamber (400) and the valve chamber is pressurised with gas.

10. An apparatus according to claim 9, wherein the gas is CO₂.

11. An apparatus according to claim 9, wherein the gas is air.

12. An apparatus according to any of claims 9 to 11, wherein the pressure of the gas is 21 bar.

13. An apparatus according to any of claims 9 to 12, wherein the valve chamber is pressurised via a Schrader valve (9) in the first end plate (51).

14. A valve (40) for use in the apparatus of any of the preceding claims, comprising a tubular bar having a hollow core which runs axially and the full length of the valve (40), the tubular bar comprising an inlet port (401) in the form of an aperture in a wall portion of the tubular bar and an opening at the distal end, wherein a shuttle (403) housed within the core of the bar may travel axially within said core and across the inlet port (401).

15. A valve according to claim 14, wherein the freedom of travel of the shuttle (403) is restricted by a step proximate the distal end of the valve (40) and a threaded adapter (404) proximate the proximal end of the valve (40).

16. A valve according to claim 8, wherein the step and the threaded adapter (404) form a pressure tight seal with the core of the valve (40) via a first O-ring (405) proximate the distal end of the valve (40) and a second O-ring (406) proximate the proximal end of the valve (40).

17. A valve according to any of claims 14 to 16, wherein a Presta (RTM) valve (407) is fixed axially at its distal end to the proximal end of the threaded adapter (404) and a coupler (408) is fixed axially at its distal end to the proximal end of the Presta (RTM) valve (407).

18. A valve according to claim 17, wherein the coupler (408) is fixed axially at its proximal end to the distal end of a motor-gearbox (409).

19. A valve according to claim 18, wherein the motor-gearbox locates within the core of the valve (40) via a surrounding tubular shroud (410).

20. A cartridge for use in the apparatus of any of claims 1 to 13, comprising a hollow tube (311) with a plug (312) at one end and a piston (313) at the other end.

21. A cartridge according to claim 20, wherein the plug (312) is circular and comprises an aperture (314) at its centre such that spoiling fluid from the cartridge can pass through the middle of the plug (312).

22. A cartridge according to claim 21, wherein fluid is prevented from passing through the aperture (314) at the centre of the plug (312) by a membrane (315).

23. A cartridge according to claim 22, wherein the membrane (315) comprises low density polyethylene (LDPE).

24. A cartridge according to claim 23, the cartridge formed over the plug (312) and aperture (314), and positioned between the plug (312) and the hollow tube (311).

25. A cartridge according to any of claims 20 to 24, wherein the plug (312) is sized so as to form a friction tight fit with the hollow tube (311).

26. A cartridge according to claim 25, wherein the plug (312) holds the membrane (315) in place.

27. A cartridge according to any of claims 20 to 26, wherein the piston (313) is circular in shape and friction tight fitted into the end of the hollow tube (311) opposite the plug (312).

28. A cartridge according to any of claims 20 to 27, wherein the piston (313) comprises an aperture (316) at its centre which is sealed with a removable bung (317).

29. A cartridge according to claim 28, wherein the aperture (316) in the piston (313) provides an opening enabling the cartridge to be filled with spoiling fluid.

30. A cartridge according to claim 29, wherein the bung (317) has a hermetic seal around the circumference.

31. A cartridge according to any of claims 20 to 30, wherein the plug (312) has a hermetic seal around the circumference.

32. A cartridge according to any of claims 20 to 31, wherein the piston (313) has a hermetic seal around the circumference.

33. A method of spoiling cash arranged in a block formation within a cassette (100), the method comprising the steps of;
detecting an attempted theft,
activating a valve (40) configured to release spoiling fluid,
dispersing spoiling fluid over opposing ends of banknotes (103) contained in the cassette (100),
keeping a central portion of the banknotes (103) substantially free from spoiling fluid after said fluid has been dispersed.

34. A method according to claim 33, wherein the spoiling fluid is adhesive.

35. A method according to claim 33 or claim 34, wherein the step of activating a valve (40) configured to release spoiling fluid is performed by activating a motor-gearbox.

36. A method according to claim 35, wherein the motor-gearbox (409) is coupled to a Presta (RTM) valve (407).

37. A method according to claim 35 or 36, wherein gas is released to flow through the valve (40) and escape around the motor-gearbox (409).

38. A method according to claim 36 or 37, wherein the resulting pressure drop in the valve (40) causes a gas transfer which moves a shuttle (403) across an inlet port (401) to open an outlet port (402) and close the Presta (RTM) valve (407).

39. A method according to claim 38, wherein the gas transfers via channels (7) to at least one piston (313).

40. A method according to claim 39, wherein the step of dispersing spoiling fluid over opposing ends of banknotes (103) comprises the gas forcing the at least one piston to move the spoiling fluid and rupture a membrane (315) containing said fluid such that the spoiling fluid can now disperse over the banknotes (103).

41. A method according to any of claims 33 to 40, wherein the spoiling fluid is dispersed via ricocheting off note guides (104) positioned in the cassette.

42. A method according to any of claims 33 to 41, wherein the step of detecting an attempted theft is via a motion or tilt sensor.

43. An apparatus (10) for spoiling banknotes (103) according to any of claims 1 to 13, comprising a valve according to any of claims 14 to 19.

44. An apparatus (10) for spoiling banknotes (103) according to any of claims 1 to 13, comprising a cartridge according to any of claims 20 to 32.

45. An apparatus (10) for spoiling banknotes (103) according to any of claims 1 to 13 comprising a valve according to any of claims 14 to 19 and a cartridge according to any of claims 20 to 32.

46. A method according to any of claims 33 to 42 of spoiling cash arranged in an apparatus according to any of claim 1 to 13, 43, 44 or 45.
